(19) United States
(12) Patent Application Publication
(10) Pub. No.: US 2008/0193205 A1
(43) Pub. Date: Aug. 14, 2008

(54) Method for forming a firm structure universal connector and the device formed by the method

(76) Inventors: Ying-Hao Peng, Taichung (TW); Chia-Hui Peng, Taichung (TW)

Correspondence Address: Ying-Hao Peng, 235 Chung-Ho, Box 8-24, Taipei, omitted

(21) Appl. No.: 11/705,594

(22) Filed: Feb. 13, 2007

(51) Int. Cl. F16C 11/06

(52) U.S. Cl. 403/114

(57) ABSTRACT

A universal connector comprises a connecting head having an axial penetrating hole and a radial penetrating hole; an adaptor having one end formed as a ball which is formed with an axial penetrating hole; a pin passing the axial penetrating hole of the adaptor and the radial penetrating hole of the connecting head so that the connecting head is swingable. The pin is made of hard metal. A spring is located within the connecting head, and resists against the ball of the adaptor; two ends of the pin tightly sealing two openings of the radial penetrating hole and a sleeve integrally formed at one end of the adaptor. The method for assembling the pin to the adaptor comprises the steps of: welding the two ends of the pin; cooling the pin at two ends of the radial penetrating hole; and polishing the two ends of the pin.

### FIELD OF THE INVENTION

The present invention relates to connectors, and particularly to a universal connector, wherein the connecting head and the adaptor are firmly secured. The adaptor has a smooth outlook.

### BACKGROUND OF THE INVENTION

Referring to FIGS. 1A and 1B, in the prior art, a universal connector comprises a connecting head 11 having an axial penetrating hole 111 and a radial penetrating hole 112; an inner wall of the axial penetrating hole 111 being formed as a stepped surface so as to form with two sections which has different diameters; one small section serving for receiving a manual operated spanner, or a pneumatic tool, or an electromotive tool and another great section serves for receiving a spring and an adaptor; an adaptor 14 having one end formed as a ball 141 which is formed with an axial penetrating hole 141; a pin passing the axial penetrating hole 141 of the adaptor 14 and the radial penetrating hole 112 of the connecting head 11 so that the connecting head 11 is swingable within the axial penetrating hole 111 of the connecting head 11; a spring 12 located within a great section of the connecting head 11, and resisting against the ball 141 of the adaptor 14; two ends of the pin tightly sealing two openings of the radial penetrating hole of the connecting head. In the prior art, two ends 131, 132 of the pin protrudes out of the adaptor 24 and then are punched so as to seal the two openings at two ends of the radial penetrating hole 112 of the connecting head 11. However the prior art pin is made of soft material and thus it is easy to be destroyed because the universal connector is used with a pneumatic tool or a manual operated spanner which applies great force to the connectors.

Referring to FIGS. 2(A) and 2(B), it is illustrated that in the opening of the radial penetrating hole 112 of the connecting head 11, the ends of the pin 13′ is sealed with C rings 15. Each C ring 15 has a notch 151. No punching operation is used. However in operation, generally, the user will hold the outside of the connecting head 11 so as to be in contact to the connecting head 11. However the arrangement of the C ring will rub the user's hand so as to hurt the hand.

### SUMMARY OF THE INVENTION

Accordingly, the primary object of the present invention is to provide a universal connector, wherein the connecting head and the adaptor can be firmly secured. The adaptor has a smooth outlook.

To achieve above objects, the present invention provides a universal connector comprising: a connecting head having an axial penetrating hole and a radial penetrating hole; an inner wall of the axial penetrating hole being formed as a stepped surface so as to form with two sections which are different diameters; one small section serving for receiving a manual operated spanner, or a pneumatic tool, or an electromotive tool and another great section serves for receiving a spring and an adaptor; an adaptor having one end formed as a ball which is formed with an axial penetrating hole; a pin passing the axial penetrating hole of the adaptor and the radial penetrating hole of the connecting head so that the connecting head is swingable within the axial penetrating hole of the connecting head; a spring located within a great section of the connecting head, and resisting against the ball of the adaptor; two ends of the pin tightly sealing two openings of the radial penetrating hole of the connecting head.

A sleeve is integrally formed at one end of the adaptor being integrally; the sleeve having a receiving hole for receiving a rectangular screw or a hexagonal screw; wherein in operation, a pneumatic tool or a manual operated spanner is engaged to the penetrating hole of the connecting head so as to tighten or release the screw; by the adaptor and the spring, the sleeve can be adjusted to any desired orientation.

In another form, a rectangular joint integrally formed at one end of the adaptor; one end of the joint being formed with a receiving hole for receiving a spring and a steel ball; an opening of the receiving hole is punched so as to seal the steel ball therein without falling out; the steel ball being elastic. An extending rod is connected to the joint; one end of the extending rod is installed with a recess for receiving the joint; a steel ball serves to tightly engage the joint and the extending rod; and another end of the extending rod has another joint; a steel ball is received in a recess of the joint of the extending rod.

The various objects and advantages of the present invention will be more readily understood from the following detailed description when read in conjunction with the appended drawing.

### BRIEF DESCRIPTION OF THE DRAWINGS

FIGS. 1(A), 1(B) show a prior art universal connector.

FIGS. 2(A), 2(B) show another prior art universal connector.

FIG. 3 is an exploded perspective view of the present invention.

FIGS. 4(A), 4(B) and 4(C) are cross sectional views showing the manufacturing process of the pin in the present invention.

FIG. 5 is a flow diagram showing the manufacturing process of the present invention.

FIG. 6 is an exploded perspective view of the first embodiment of the present invention.

FIG. 7 shows the use of the present invention, where the present invention is used with a pneumatic tool.

FIG. 8 shows the use of the present invention, wherein the present invention is used with a manual operated spanner.

FIG. 9 is an exploded perspective view of the second embodiment of the present invention.

FIG. 10 shows the use of the structure in FIG. 9, which is used with a pneumatic tool.

FIG. 11 shows the use of the structure in FIG. 9, which is used with a manual operated spanner.

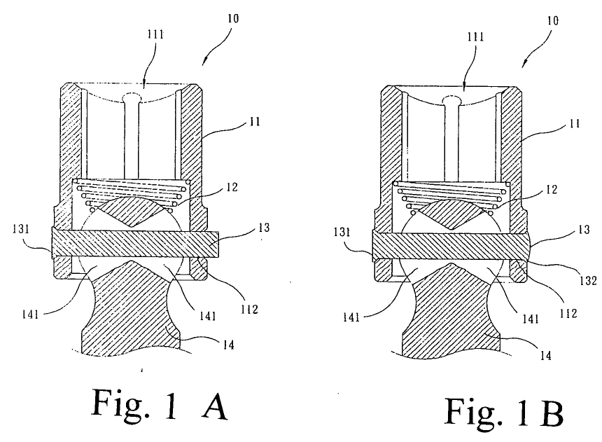

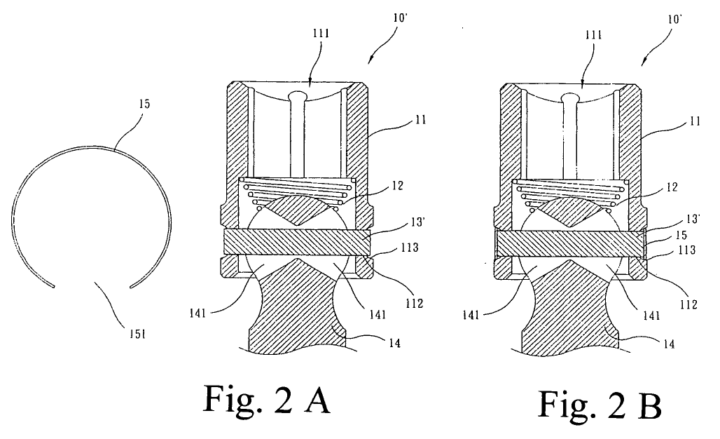

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

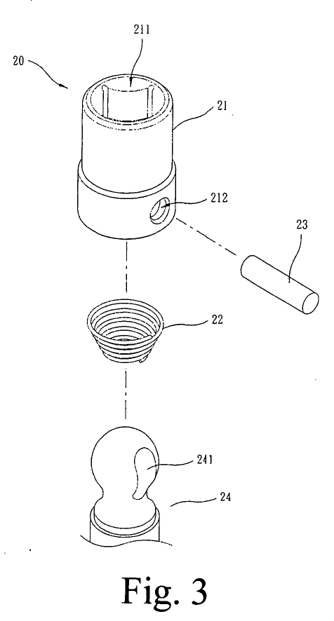

Referring to FIGS. 3 to 5, the structure of the present invention is illustrated. The present invention has the following elements.

A connecting head 21 has an axial penetrating hole 211 and a radial penetrating hole 212. An inner wall of the axial penetrating hole 211 is formed as a stepped surface so as to form with two sections which are different diameters. One small section serve for receiving a manual operated spanner, or a pneumatic tool, or an electromotive tool and another great section serves for receiving a spring 22 and an adaptor 24.

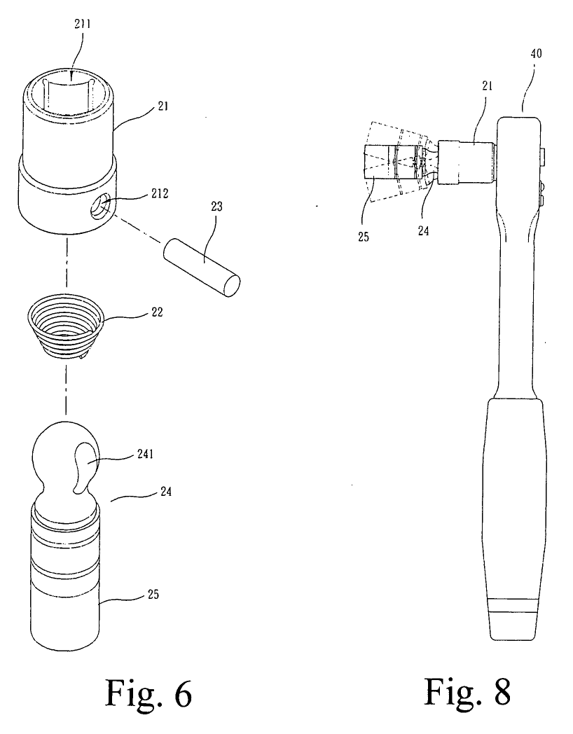

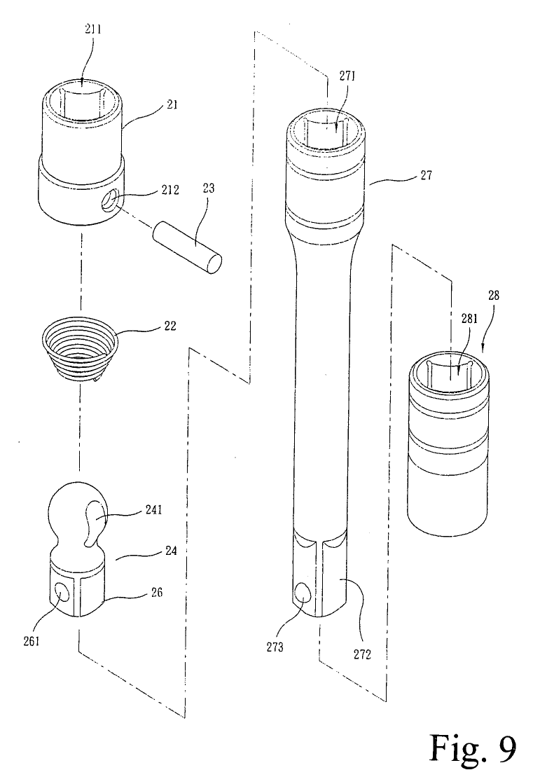

The adaptor 24 has one end formed as a ball which is formed with an axial penetrating hole 241. Another end of the adaptor 24 may be formed with a joint 26 (referring to FIG. 9) or with a sleeve 25 (referring to FIG. 6). When the axial penetrating hole 241 of the adaptor 24 is aligned to the axial penetrating hole 211 of the connecting head 21, a pin 22 passes the axial penetrating hole 241 of the adaptor 24 and the radial penetrating hole 212 of the connecting head 21 so that the connecting head 21 is swingable within the axial penetrating hole of the connecting head 21.

The spring 22 is located within a great section of the connecting head 21, and resists against the ball of the adaptor 24.

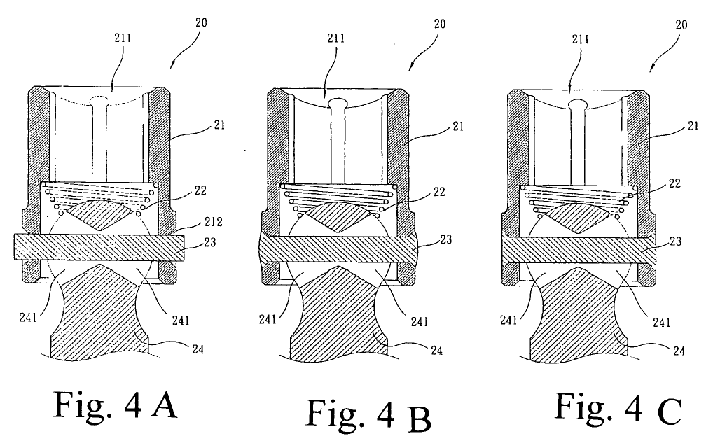

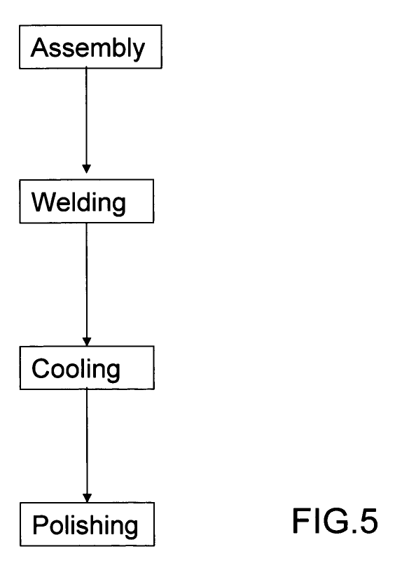

The pin 22 is made of hard metal. Two ends of the pin 22 tightly seal two openings of the radial penetrating hole 212 of the connecting head 21. In the manufacturing process, the two ends of the pin 22 protrude from the openings of the radial penetrating hole 212. Then the two ends are thermally welded, cooled and polished so as to seal the two openings without any gap, see FIGS. 5 and 4(A) to 4(C).

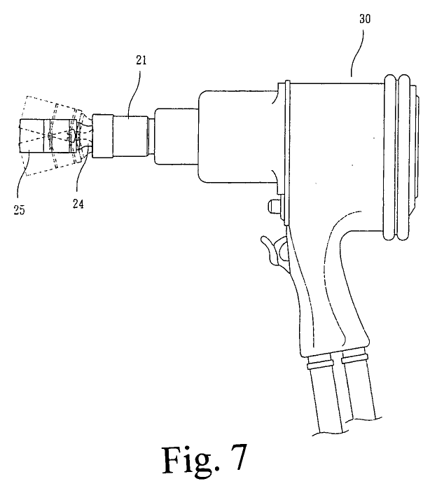

Referring to FIGS. 6 to 8, one end of the adaptor 24 is integrally formed with a sleeve 25. The sleeve 25 has a receiving hole (not shown) which has a rectangular or hexagonal shape for receiving a rectangular screw or a hexagonal screw. A pneumatic tool 30 (referring to FIG. 7) or a manual operated spanner 40 is engaged to the penetrating hole 211 of the connecting head 21 so as to tighten or release the screw. By the adaptor 24 and the spring 22, the sleeve 25 can be adjusted to any desired orientation.

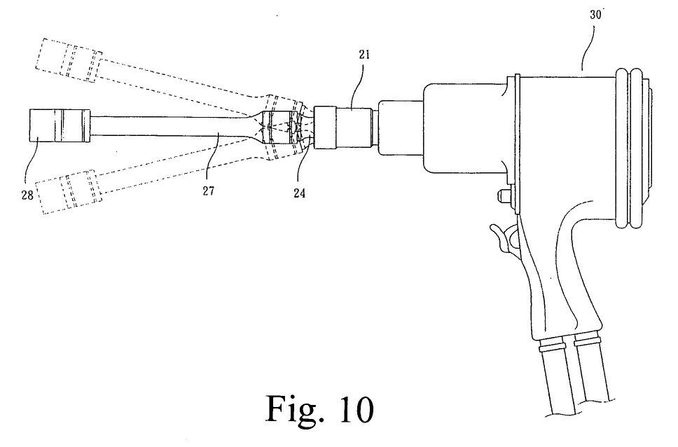

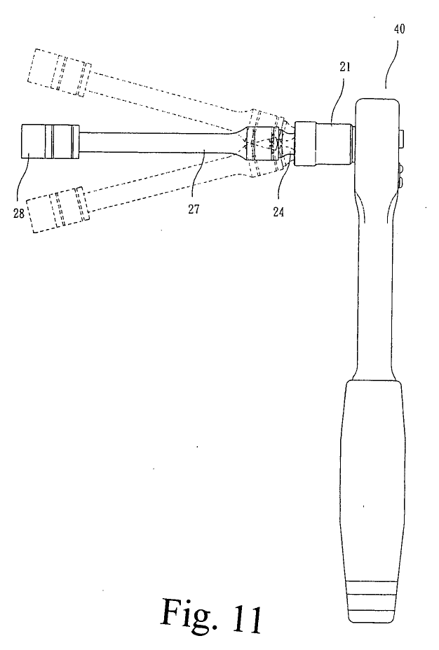

Referring to FIGS. 9 to 11, one end of the adaptor 24 is integrally formed with a rectangular joint 26. One end of the joint 26 is formed with a receiving hole for receiving a spring and a steel ball 261. An opening of the receiving hole is punched so as to seal the steel ball 261 therein without falling out. The steel ball 261 is elastic. The joint 26 is further connected with an extending rod 27 and a socket 28 for screwing a screw in a placed farther place. One end of the extending rod 27 is installed with a recess 271 for receiving the joint 26. A steel ball 261 serves to tightly engage the joint 26 and the extending rod 27. Another end of the extending rod 27 has another joint 272. A steel ball 273 is received in a recess of the joint 272 of the extending rod 27. The joint 272 can be inserted into a recess 281 of the socket 28. Another end of the socket 281 has a receiving hole (not shown) which may have a rectangular or hexagonal shape. A pneumatic tool 30 or a manual operated spanner 40 is engageable to the penetrating hole 211 of the connecting head 21. The receiving hole of the socket 28 serves to receive a screw so as to screw or release the screw in a farther place.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for forming a swingable adaptor in a universal connector; the universal connector comprising a connecting head having an axial penetrating hole and a radial penetrating hole; an inner wall of the axial penetrating bole being formed as a stepped surface so as to form with two sections which have different diameters; one small section serving for receiving a manual operated spanner, or a pneumatic tool, or an electromotive tool and another great section serves for receiving a spring and an adaptor; the adaptor having one end formed as a ball which is formed with an axial penetrating hole; a pin passing the axial penetrating hole of the adaptor and the radial penetrating hole of the connecting head so that the connecting head is swingable within the axial penetrating hole of the connecting head; the method comprising the steps of:
assembling the pin into the radial penetrating hole of the connecting head; the two ends of the pin protruding from the openings of the radial penetrating hole;
welding the two ends so as to seal the two openings of the radisl penetrating hole of the connecting head without any gap;
cooling the pin at two ends of the radial penetrating hole; and
polishing the two ends of the pin.

2. A universal connector comprising:
a connecting head having an axial penetrating hole and a radial penetrating hole; an inner wall of the axial penetrating hole being formed as a stepped surface so as to form with two sections which have different diameters; one small section serving for receiving a manual operated spanner, or a pneumatic tool, or an electromotive tool and another great section serves for receiving a spring and an adaptor;
an adaptor having one end formed as a ball which is formed with an axial penetrating hole; a pin passing the axial penetrating hole of the adaptor and the radial penetrating hole of the connecting head so that the connecting head is swingable within the axial penetrating hole of the connecting head; wherein the pin is made of hard metal;
a spring located within the great section of the connecting head, and resisting against the ball of the adaptor;
two ends of the pin tightly sealing two openings of the radial penetrating hole of the connecting head;
a sleeve integrally formed at one end of the adaptor; the sleeve having a receiving hole for receiving a rectangular screw or a hexagonal screw;
wherein in operation, a pneumatic tool or a manual operated spanner is engaged to the penetrating hole of the connecting head so as to tighten or release the screw; by the adaptor and the spring, the sleeve can be adjusted to any desired orientation.

3. A universal connector comprising:
a connecting head having an axial penetrating hole and a radial penetrating hole; an inner wall of the axial penetrating hole being formed as a stepped surface so as to form with two sections which have different diameters; one small section serving for receiving a manual operated spanner, or a pneumatic tool, or an electromotive tool and another great section serves for receiving a spring and an adaptor;
an adaptor having one end formed as a ball which is formed with an axial penetrating hole; a pin passing the axial penetrating hole of the adaptor and the radial penetrating hole of the connecting head so that the connecting head is swingable within the axial penetrating hole of the connecting head;
a spring located within the great section of the connecting head, and resisting against the ball of the adaptor;
two ends of the pin tightly sealing two openings of the radial penetrating hole of the connecting head;
a rectangular joint integrally formed at one end of the adaptor; one end of the joint being formed with a receiving hole for receiving a spring and a steel ball; an opening of the receiving hole is punched so as to seal the steel ball therein without falling out; the steel ball being elastic.

4. The universal connector as claimed in claim 2, further comprising:
an extending rod connected to the joint; one end of the extending rod is installed with a recess for receiving the joint; a steel ball serves to tightly engage the joint and the extending rod; and another end of the extending rod has another joint; and a steel ball is received in a recess of the joint of the extending rod.

5. The universal connector as claimed in claim 1, further comprising a socket having a recess for receiving the joint; the joint is inserted into the recess of the socket; another end of the socket has a receiving hole; which has a rectangular or hexagonal shape; and
wherein in operation, a pneumatic tool or a manual operated spanner can be engaged to the penetrating hole of the connecting head; the receiving hole of the socket serves to receive a screw so as to screw or release the screw in a farther place.

6. The universal connector as claimed in claim 1, where in the pin made of hard metal.
